(19) United States
(12) Patent Application Publication
(10) Pub. No.: US 2007/0269113 A1
(43) Pub. Date: Nov. 22, 2007

(54) METHOD AND RELATED APPARATUS FOR DETERMINING IMAGE CHARACTERISTICS

(76) Inventor: Po-Wei Chao, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/744,888

(22) Filed: May 7, 2007

(30) Foreign Application Priority Data
May 17, 2006 (TW) 095117437

(51) Int. Cl. G06K 9/48

(52) U.S. Cl. 382/199

(57) ABSTRACT

The present invention discloses an apparatus for determining characteristic(s) to which a target location of an image corresponds. The apparatus includes an edge detector and a characteristic detector. The edge detector performs an edge detection on each of a plurality of detection areas of the image so as to generate a plurality of edge detection results. The characteristic detector is coupled to the edge detector and analyzes the edge detection results so as to determine characteristic(s) to which the target location corresponds. The detection areas correspond to the target location.

### BACKGROUND OF THE INVENTION

1. Field of the Invention

The present invention relates to determining image characteristics, and more particularly, to a method and related apparatus for determining image characteristics by edge detection.

2. Description of the Prior Art

Edge detection is often applied in related fields of digital images or digital videos. For example, when performing image scaling, de-interlacing, noise reduction, or image enhancement, edge detection is usually adopted.

Sobel filters and Laplace filters are two kinds of filters utilized for edge detecting. FIG. 1 shows four examples of a Sobel filter 110, 120, 130, and 140, that are respectively utilized for determining whether a pixel corresponds to a horizontal edge, a vertical edge, a right tilted edge, or a left tilted edge. For a target pixel P (X, Y) in an image, a conventional method will utilize a pixel of a detection area to which the target pixel P (X, Y) corresponds (the detection area has a fixed size and a fixed location) as an input pixel of the Sobel mask, and determine an edge to which the target pixel P (X, Y) corresponds according to masked values generated by utilizing the Sobel mask in order to perform the operation on the pixel of the detection area. Under a general condition, the conventional method will utilize a rectangle (the size is fixed as 3 pixels*3 pixels) formed by the four pixels P (X−1, Y−1), P (X+1, Y−1), P (X−1, Y+1), and P (X+1, Y+1) as the detection area mentioned above. However, the method of “performing an edge detection according to a pixel of a fixed detection area” is usually unable to identify a pattern to which the image specifically belongs, and is unable to select the best interpolation way according to the identified image pattern for an interpolation unit in the rear.

### SUMMARY OF THE INVENTION

It is therefore one of the objectives of the present invention to provide a method and related apparatus for generating characteristics of an image by edge detection.

An embodiment of the present invention discloses an image characteristic determining method for determining which characteristic a target location of an image corresponds to. The image characteristic determining method includes: performing an edge detection on each of a plurality of detection areas of the image so as to generate a plurality of edge detection results; and analyzing the edge detection results so as to determine which characteristic the target location corresponds to, wherein the detection areas correspond to the target location.

An embodiment of the present invention discloses an image characteristic determining apparatus for determining which characteristic a target location of an image corresponds to. The image characteristic determining apparatus includes: an edge detector, for performing an edge detection on each of a plurality of detection areas of the image so as to generate a plurality of edge detection results; and a characteristic detector, coupled to the edge detector, for analyzing the edge detection results so as to determine which characteristic the target location corresponds to, wherein the detection areas correspond to the target location.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing four examples of a Sobel filter.

FIG. 2 is a diagram of a required processing image of each embodiment of the present invention.

FIG. 3 is a diagram of an apparatus according to a first embodiment of the present invention.

FIG. 4 is a diagram of an apparatus according to a second embodiment of the present invention.

FIG. 5 is a diagram of an apparatus according to a third embodiment of the present invention.

FIG. 6 is a diagram of a required processing image of each embodiment of the present invention.

### DETAILED DESCRIPTION

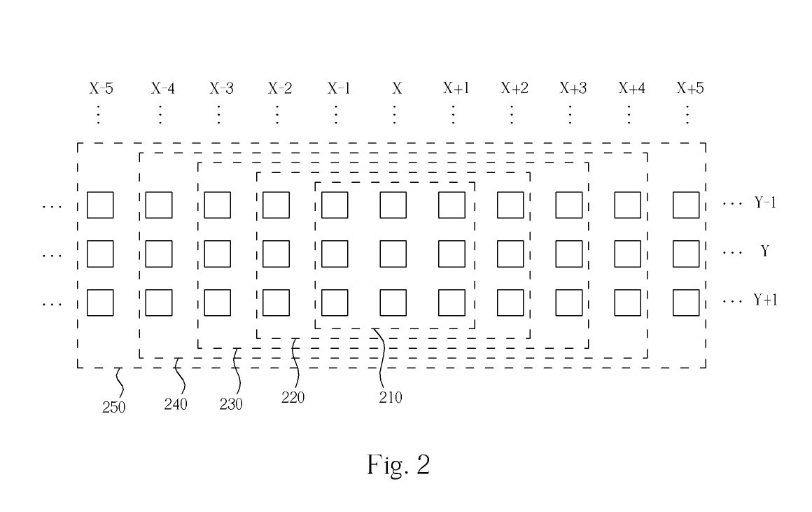

Please refer to FIG. 2. FIG. 2 is a diagram of a required processing image of each embodiment of the present invention. For example, the image can be a single page image (such as an image waiting for scaling) or a field of an interlacing video. For a target pixel P (X, Y) in the image, each embodiment of the present invention will select a plurality of detection areas corresponding to the target pixel P (X, Y), and perform an edge detection on each of the detection areas of the image so as to generate a plurality of edge detection results in a step 1020, and analyze the edge detection results so as to determine which characteristic the target location corresponds to in a step 1040.

For example, the target pixel P (X, Y) location can be a center of the detection areas, which are rectangles of different area sizes. The edge detection can be a Sobel edge detection or other known edge detections. For convenience of operation, the edge detection can be performed on the detection areas sequentially, e.g. from the smallest area size to the largest area size, so as to generate the edge detection results according to the area sizes of the detection areas in the step 1020. Of course, the limitations: “performing the edge detection sequentially according to the area sizes”, is not necessary for the present invention.

Please continue to refer to FIG. 2. According to the area sizes, the detection areas corresponding to the target pixel P (X, Y) from the smallest area size to the largest area size can be, respectively, a first detection area 210 (which is a rectangle of 3 pixels*3 pixels), a second detection area 220 (which is a rectangle of 5 pixels*3 pixels), a third detection area 230 (which is a rectangle of 7 pixels*3 pixels), a fourth detection area 240 (which is a rectangle of 9 pixels*3 pixels), and a fifth detection area 250 (which is a rectangle of 11 pixels*3 pixels). In step 1020, when performing the Sobel edge detection on the Mₜₕ detection area of the detection areas, pixels P (X−M, Y−1), P (X, Y−1), and P (X+M, Y−1) can be utilized as three input pixels of an above horizontal line, pixels P (X−M, Y), P (X, Y), and P (X+M, Y) can be utilized as three input pixels of a center horizontal line, and pixels P (X−M, Y+1), P (X, Y+1), P (X+M, Y+1) can be utilized as three input pixels of a below horizontal line. Please note that each of the detection areas having different horizontal widths is only an illustration, and it is also possible that each of the detection areas has a different vertical height, or each of the detection areas has a different horizontal width and different vertical height. In addition, each of the detection areas is not restricted to being rectangular and can be other shapes.

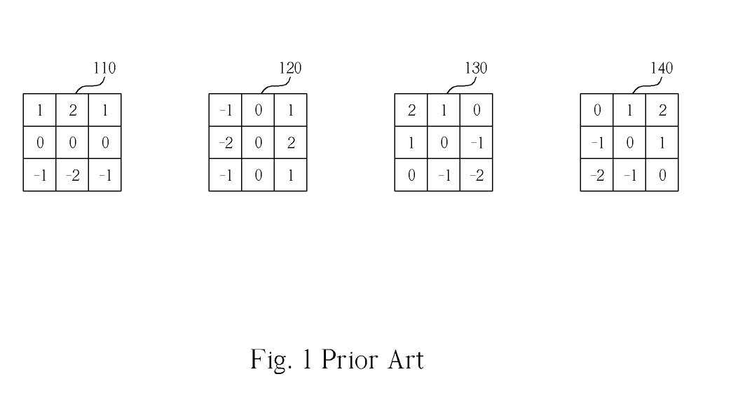

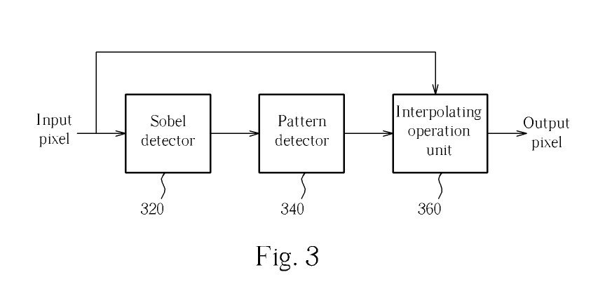

FIG. 3 is a diagram of an apparatus according to a first embodiment of the present invention. The apparatus shown in FIG. 3 includes a Sobel detector 320, a pattern detector 340, and an interpolating operation unit 360, wherein the Sobel detector 320 is utilized for performing the step 1020 mentioned above, i.e. performing the Sobel edge detection on all the detection areas so as to generate a plurality of edge detection results; therefore the Sobel detector 320 can include one Sobel mask or a plurality of Sobel masks shown in FIG. 1. The pattern detector 340 is utilized for performing the step 1040 mentioned above, i.e. analyzing the edge detection results so as to determine which pattern the target pixel P (X, Y) corresponds to (in other words, the pattern corresponding to the target pixel P (X, Y) is an example of a characteristic corresponding to the target pixel P (X, Y)).

In an example, an “edge direction” determined by utilizing the Sobel detector 320 to perform the Sobel edge detection on one of the detection areas is utilized as an “edge detection result” corresponding to the detection area. For example, alphabets N, H, R, V, and L are utilized to represent a “non edge”, “horizontal edge”, “right tilted edge”, “vertical edge”, and “left tilted edge” respectively, and when the Sobel detector 320 performs the Sobel edge detection on the first detection area 210, the second detection area 220, the third detection area 230, the fourth detection area 240, and the fifth detection area 250 to generate all the edge detection results as N, the pattern detector 340 can determine that the target pixel P (X, Y) corresponds to a “smooth pattern”. When the edge detection results change disorderly (for example, when the edge detection results of the first detection area 210, the second detection area 220, the third detection area 230, the fourth detection area 240, and the fifth detection area 250 are R, L, V, H, and N sequentially, or V, L, N, H, and R sequentially), the pattern detector 340 can determine that the target pixel P (X, Y) corresponds to a “mess pattern”. When the edge detection results are all H, the pattern detector 340 can determine that the target pixel P (X, Y) corresponds to a “horizontal edge pattern”. When the edge detection results are all V, the pattern detector 340 can determine that the target pixel P (X, Y) corresponds to a “vertical edge pattern”. When the edge detection results are all R, the pattern detector 340 can determine that the target pixel P (X, Y) corresponds to a “right tilted edge pattern”. When the edge detection results of the first detection area 210, the second detection area 220, the third detection area 230, the fourth detection area 240, and the fifth detection area 250 are H, H, H, R, and R sequentially, the pattern detector 340 can determine that the target pixel P (X, Y) corresponds to a “low angle and right tilted edge pattern”. In other words, the pattern detector 340 can determine what a variation trend around the target pixel P (X, Y) is by analyzing the edge detection results so as to determine the pattern to which the target pixel P (X, Y) corresponds.

In another example, a masked value generated by utilizing the Sobel detector 320 to perform the Sobel edge detection of at least one direction on one of the detection areas is utilized as an “edge detection result” corresponding to the detection area. For example, if the horizontal Sobel masked values generated by utilizing the Sobel detector 320 to perform the horizontal Sobel edge detection on the first detection area 210, the second detection area 220, the third detection area 230, the fourth detection area 240, and the fifth detection area 250 sequentially vary up and down (or positively and negatively), then the pattern detector 340 can determine that the target pixel P (X, Y) corresponds to a “mess pattern”. For example, when the horizontal Sobel mask 110 shown in FIG. 1 is utilized to perform the edge detection on the Mₜₕ detection area of the detection areas, assume that the pixels P (X−M, Y−1), P (X, Y−1), and P (X+M, Y−1) of the above horizontal line are all equal to 200, the pixels P (X−M, Y), P (X, Y), and P (X+M, Y) of the center horizontal line are all equal to 100, and the pixels P (X−M, Y+1), P (X, Y+1), and P (X+M, Y+1) of the below horizontal line are all equal to 10, and then the masked value can be calculated by [200×1+200×2+200×1+100×0+100×0+100×0+10×(−1)+10×(−2)+10×(−1)], and the calculated masked value will be 760.

After the pattern detector 340 determines the pattern to which the target pixel P (X, Y) corresponds, the pattern detector 340 can output the determining results to the interpolating operation unit 360 in the rear. When the interpolating operation unit 360 is required to interpolate and generate pixels (not shown in FIG. 2) around the target pixel P (X, Y), the interpolating operation unit 360 can determine an interpolation method (such as an intra-field interpolation or an inter-field interpolation) or an interpolation search range/search angle in the interpolating operation according to the pattern to which the target pixel P (X, Y) corresponds as determined by the pattern detector 340, and a better interpolation effect will be attained. Of course, the interpolating operation unit 360 mentioned here is only an illustration. In other embodiments, other kinds of image (video) processing units such as an image scaling operation unit, a video de-interlacing operation unit, a noise reducing operation unit, or an image enhancing operation unit can also be coupled to the pattern detector 340.

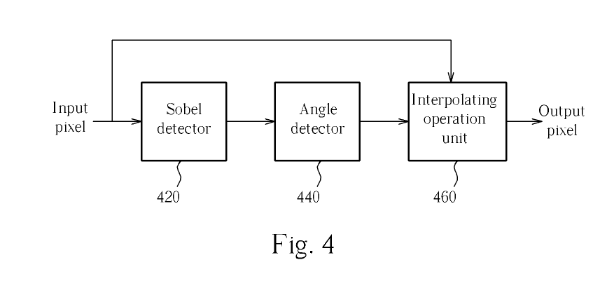

FIG. 4 is a diagram of an apparatus according to a second embodiment of the present invention. The apparatus shown in FIG. 4 includes a Sobel detector 420, an angle detector 440, and an interpolating operation unit 460, wherein the Sobel detector 420 is utilized for performing the step 1020 mentioned above, and the angle detector 440 is utilized for performing the step 1040 mentioned above. In this second embodiment, a best (or better) edge angle to which the target pixel P (X, Y) corresponds, as determined by utilizing the angle detector 440, is utilized as a “characteristic corresponding to the detection area”. The Sobel detector 420 can include a horizontal Sobel mask 110 and a vertical Sobel mask 120, and the Sobel detector 420 can utilize masked values respectively generated by utilizing the horizontal Sobel mask 110 and the vertical Sobel mask 120 to perform the operation on one of the detection areas as an “edge detection result”. As to “analyzing the edge detection results”, it can be “the angle detector 440 analyzing the (horizontal Sobel masked value, vertical Sobel masked value) corresponding to the detection areas”.

In an example, the angle detector 440 can determine that a detection area corresponds to the best edge angle when the horizontal Sobel masked value is the most similar to the vertical Sobel masked value. For example, if the (horizontal Sobel masked value, vertical Sobel masked value) generated by performing the Sobel edge detection on the first detection area 210, the second detection area 220, the third detection area 230, the fourth detection area 240, and the fifth detection area, respectively, 250 are (30, 70), (40, 60), (50, 50), (60, 40), and (70, 30) then the angle detector 440 can determine that the third detection area 230 provides the best edge angle because the horizontal Sobel masked value and the vertical Sobel masked value are the most similar to each other. In other words, the diagonal line of the third detection area 230 provides the best edge angle for the target pixel P (X, Y) in the example mentioned above. Of course, the angle detector 440 can also determine that each angle is a better edge angle when the difference between the horizontal Sobel masked value and the vertical Sobel masked value is smaller than a predetermined threshold value (such as 25), and then a pixel difference detector (not shown) in the interpolating operation unit 460 will select the best edge angle from the better edge angles. Taking the above example for illustration, the angle detector 440 can determine that the diagonal lines of the second detection area 220, the third detection area 230, and the fourth detection area 240 provide the better edge angles for the target pixel P (X, Y).

After the angle detector 440 determines the best (or better) edge angle of the target pixel P (X, Y), the angle detector 440 can output the determining results to the interpolating operation unit 460 in the rear. When the interpolating operation unit 460 is required to interpolate and generate pixels (not shown in FIG. 2) around the target pixel P (X, Y), the interpolating operation unit 460 can determine an interpolation search range or search angle in the interpolating operation according to the best (or better) edge angle of the target pixel P (X, Y) as determined by the angle detector 440.

In addition, in an example, the Sobel detector 420 can only include the vertical Sobel mask 120, and the Sobel detector 420 can utilize the vertical masked values generated by utilizing the vertical Sobel mask 120 as an “edge detection result”. As to “analyzing the edge detection results”, it can include “the angle detector 440 analyzing the vertical Sobel masked values corresponding to the detection areas”. The angle detector 440 can determine that a transition happens to the image when the vertical Sobel masked values have positive or negative variations, and the angle detector 440 will notify the interpolating operation unit 460 to “stop searching areas here and do not continue”, in order to avoid errors in the image detection.

Of course, the interpolating operation unit 460 shown in FIG. 4 is only for illustration. In other embodiments, other kinds of image (video) processing units such as an image scaling operation unit, a video de-interlacing operation unit, a noise reducing operation unit, or an image enhancing operation unit can also be coupled to the angle detector 440.

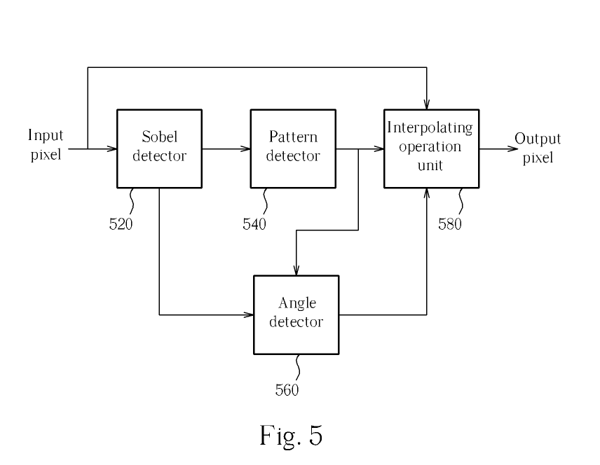

FIG. 5 is a diagram of an apparatus according to a third embodiment of the present invention. The apparatus shown in FIG. 5 includes a Sobel detector 520, a pattern detector 540, an angle detector 560, and an interpolating operation unit 580, wherein the functions of the Sobel detector 520 are similar to the functions of the Sobel detector 320 and 420 mentioned above, and the functions of the pattern detector 540 are similar to the functions of the pattern detector 340 mentioned above, and therefore details of the functions of these two components is omitted for the sake of brevity. The angle detector 560 is utilized to take the pattern determining results of the pattern detector 540 on the target pixel P (X, Y) and further analyze the edge detection results generated by the Sobel detector 520 in order to determine the best (or better) edge angle of the target pixel P (X, Y). For example, when the pattern detector 540 determines that the target pixel P (X, Y) corresponds to the mess pattern, the angle detector 560 can decide not to perform the best (or better) edge angle detecting operation (because the target pixel P (X, Y) will not have the best (or better) edge angle). When the pattern detector 540 determines that the target pixel P (X, Y) corresponds to the right tilted edge pattern, the angle detector 560 only needs to perform the best (or better) edge angle detecting operation in the right tilted angle.

The interpolating operation unit 580 receives the pattern/edge determining results of the target pixel P (X, Y) from the pattern detector 540 and the angle detector 560, and interpolates pixels (not shown in FIG. 2) around the target pixel P (X, Y) according to the received pattern/edge determining results of the target pixel P (X, Y). For example, when the pattern detector 540 determines that the target pixel P (X, Y) corresponds to the mess pattern and the angle detector 560 does not perform the best (or better) edge angle detecting operation, the interpolating operation unit 580 can determine a smaller interpolating operation range in order to perform the intra-field interpolation according to the determining results mentioned above. Of course, the interpolating operation unit 580 shown in FIG. 5 is only for illustration. In other embodiments, other kinds of image (video) processing units such as an image scaling operation unit, a video de-interlacing operation unit, a noise reducing operation unit, or an image enhancing operation unit can also be coupled to the angle detector 540.

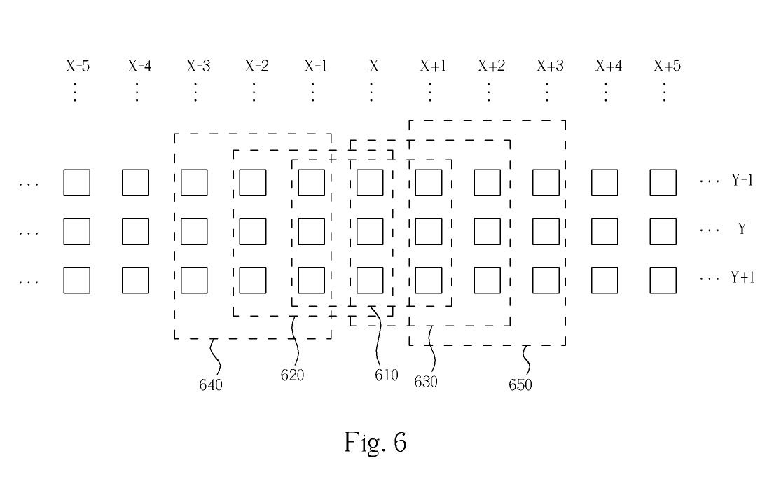

Please note that, in the example shown in FIG. 2, although the detection areas are rectangles of different sizes, and the target location (i.e. the target pixel P (X, Y)) of the required pattern is the center of all these detection areas, this is not a necessary limitation of the present invention. In other examples, the detection areas can be rectangles of the same size (such as the size of 3 pixels*3 pixels), and the detection areas are distributed symmetrically by taking the target location (i.e. the target pixel P (X, Y)) as a reference; an example is shown in FIG. 6. The edge detection is not necessary to be performed according to the sequence of the first detection area 610, the second detection area 620, the third detection area 630, the fourth detection area 640, and the fifth detection area 650, and can also be performed on the detection areas according to other sequences.

In addition, please note that the three embodiments shown in FIG. 3, FIG. 4, and FIG. 5 are only for illustration, and a person of ordinary skill in the art is able to apply the concept of the present invention to related fields of various image (video) processing. Furthermore, although all the above-mentioned embodiments utilizes the Sobel detector as the edge detector, a person of ordinary skill in the art is able to utilize other kinds of edge detectors (such as a Laplace edge detector) to generate a required edge detection result utilizing the concept of the present invention

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image characteristic determining method, for determining a characteristic to which a target location of an image corresponds, the image characteristic determining method comprising:
performing an edge detection on each of a plurality of detection areas of the image so as to generate a plurality of edge detection results; and
analyzing the edge detection results so as to determine the characteristic to which the target location corresponds;
wherein the detection areas correspond to the target location.

2. The method of claim 1, wherein at least two of the detection areas have different area sizes.

3. The method of claim 2, wherein the step of performing the edge detection comprises:
performing the edge detection on each of the detection areas with respect to the area sizes of the detection areas.

4. The method of claim 1, wherein the target location is located in at least one of the detection areas.

5. The method of claim 4, wherein the target location is substantially a center of the detection areas.

6. The method of claim 1, wherein the detection areas are distributed symmetrically by taking the target location as a reference.

7. The method of claim 1, wherein the edge detection is a Sobel edge detection.

8. The method of claim 1, wherein the step of performing the edge detection comprises:
performing the edge detection on the detection area to generate an edge direction corresponding to the detection area, and utilizing the edge direction corresponding to the detection area as an edge detection result of the detection area.

9. The method of claim 1, wherein the step of performing the edge detection comprises:
performing the edge detection on one of the detection areas to generate at least a masked value, and utilizing the masked value as an edge detection result of the one of the detection areas.

10. The method of claim 1, wherein the step of analyzing the edge detection results comprises:
analyzing the edge detection results so as to determine a pattern to which the target location corresponds.

11. The method of claim 1, wherein the step of analyzing the edge detection results comprises:
analyzing the edge detection results so as to determine an optimal edge angle or a better edge angle to which the target location corresponds.

12. An image characteristic determining apparatus, for determining a characteristic to which a target location corresponds, the image characteristic determining apparatus comprising:
an edge detector, for performing an edge detection on each of a plurality of detection areas of an image so as to generate a plurality of edge detection results; and
a characteristic detector, coupled to the edge detector, for analyzing the edge detection results so as to determine the characteristic to which the target location corresponds;
wherein the detection areas correspond to the target location.

13. The apparatus of claim 12, wherein at least two of the detection areas have different area sizes.

14. The apparatus of claim 13, wherein the edge detector performs the edge detection on each of the detection areas of the image according to the area sizes of the detection areas.

15. The apparatus of claim 12, wherein the target location is located in at least one of the detection areas.

16. The apparatus of claim 15, wherein the target location is substantially a center of the detection areas.

17. The apparatus of claim 12, wherein the detection areas are distributed symmetrically by taking the target location as a reference.

18. The apparatus of claim 12, wherein the edge detector performs the edge detection on one of the detection areas to generate at least a manipulated value, and utilizes the manipulated value as an edge detection result of the one of the detection areas.

19. The apparatus of claim 18, wherein the manipulated value is an edge direction corresponding to the one of the detection areas.

20. The apparatus of claim 12, wherein the edge detection is a Sobel edge detection.

21. The apparatus of claim 12, wherein the characteristic detector is a pattern detector for analyzing the edge detection results so as to determine a pattern to which the target location corresponds.

22. The apparatus of claim 12, wherein the characteristic detector is an angle detector, for analyzing the edge detection results so as to determine an optimal edge angle or a better edge angle to which the target location corresponds.
